(19) United States
(12) Patent Application Publication
(10) Pub. No.: US 2015/0222731 A1
(43) Pub. Date: Aug. 6, 2015

(54) COMPUTER, GUIDE INFORMATION PROVIDING METHOD AND RECORDING MEDIUM

(71) Applicants: Go Shinohara, Tokyo (JP); Yuuji Yagi, Tokyo (JP); Hideyoshi Sakahira, Tokyo (JP)

(72) Inventors: Go Shinohara, Tokyo (JP); Yuuji Yagi, Tokyo (JP); Hideyoshi Sakahira, Tokyo (JP)

(21) Appl. No.: 14/415,262

(22) PCT Filed: Jul. 18, 2012
(86) PCT No.: PCT/JP2012/068140

§ 371 Date: Jan. 16, 2015

(51) Int. Cl. H04L 29/06; G06F 17/30; H04L 12/26

(52) U.S. Cl. CPC H04L 67/42; H04L 43/04; G06F 17/30864

(57) ABSTRACT

A subject is to utilize the relationship between work commands in the past showing concrete actions of an operator and data as results of the work commands. For this purpose, a storage unit configured to hold information associating a flow chart including at least one work procedure and showing a flow of work needed to generate predetermined data and work guide information needed to perform the work procedure is included and the flow chart and the guide information are transmitted in response to a directive from a requesting computer. Then, the requesting computer is caused to display the flow chart and the guide information, a combination of a work command issued by the requesting computer and data accessed or generated in accordance with the work command for execution of the work procedure by the requesting computer is associated with the work procedure and recorded, and the flow chart corresponding to the predetermined data and the combination of the work command and the data accessed or generated in the work procedure stored are transmitted to the requesting computer in a predetermined moment to cause the requesting computer to display the flow chart and the combination.

### TECHNICAL FIELD

The present invention relates to a computer, a guide information providing method, and a recording medium, and in particular, relates to a computer that manages relationships between work commands and data, a guide information providing method, and a recording medium.

### BACKGROUND ART

In recent years, the amount of data handled in an information processing environment is on the increase at an accelerated pace and further tends to increase also in the future. The amount of data tends to increase regardless of the type of industry such as POS data in the distribution industry and various kinds of data related to transactions thereof, various kinds of sensor data of factories/plants, traffic jam prediction and the like, and message data or image data in data sharing and communication including SNS (Social Network Service). Such data is sometimes called so-called big data.

Particularly regarding handling of data collected as the so-called big data, not only technology of collection/delivery thereof, but also technology of utilization to create/provide information of new value by linking the same type or different types of data is actively developed.

As a technology to provide suitable information to users by associating information, for example, PTL 1 provides a system in which a flow chart showing the flow of predetermined work is provided to a user computer or the like and guidance of operation needed for work in each separate work node (work procedure) constituting the flowchart is displayed. According to the technology, a flow chart showing the procedure for an operator to perform work is displayed and the flow chart, a node as each procedure constituting the flow chart, and an execution frequency of the flow chart are associated to manage so that an appropriate flow chart more desired by the operator is provided.

PTL 2 discloses a technology as a work flow system in which work to be performed by an operator is determined in accordance with information in which a work flow is defined, so that there is no transaction, and various conditions.

### CITATION LIST

### Patent Literature

PTL 1: Japanese Patent No. 4846012
PTL 2: JP 2004-126682 A

### SUMMARY OF INVENTION

### Technical Problem

When an operator performs work, needed data may be acquired by collecting data needed in processes of the work and using working commands such as SQL or CQL commands or search commands or a product of the work may be completed by utilizing documents in which useful information for performing the work is described.

However, if the method of performing the work is not clearly defined, (1) it is frequently unknown which work commands and data/documents are utilized by the operator to perform the work, posing a problem that whether the product is created by using correct work commands and correct data/documents is unknown. In addition, (2) work commands and data/documents to be utilized during work are not clear and thus, a problem is posed that work commands and reference data/documents are different from operator to operator, leading to variations in quality of products. Further, (3) when information of data/documents utilized during work is updated, a problem is posed that the operator may erroneously utilize old information without knowing the update.

### Solution to Problem

To solve the above problems, an aspect of the present invention is a computer including a storage unit configured to hold information associating a flow chart including at least one work procedure and showing a flow of work needed to generate predetermined data and work guide information needed to perform the work procedure, wherein

the flowchart and the guide information are transmitted in response to a directive from a requesting computer and the requesting computer is caused to display the flow chart and the guide information, a combination of a work command issued by the requesting computer and data accessed or generated in accordance with the work command for execution of the work procedure is associated with the work procedure and recorded, and the flow chart corresponding to the predetermined data and the combination of the work command in the work procedure stored and the data accessed or generated are transmitted to the requesting computer in a predetermined moment to cause the requesting computer to display the flow chart and the combination.

### Advantageous Effects of Invention

According to an aspect of the present invention, the relationship between actual work commands in the past showing concrete actions of an operator and a product obtained by the work commands can be utilized for work in the future.

Other problems and effects of the present invention will further be apparent from descriptions of embodiments described below.

### BRIEF DESCRIPTION OF DRAWINGS

FIG. 1 shows the configuration of a computer system according to a first embodiment to which the present invention is applied.

FIG. 2 shows a display example of guide information displayed on a client device according to the first embodiment.

FIG. 3 shows a display example of guide information displayed on the client device according to the first embodiment.

FIG. 4 shows an example of a flow table according to the first embodiment.

FIG. 5 shows an example of a flow information table according to the first embodiment.

FIG. 6 shows an example of an actual work table according to the first embodiment.

FIG. 7 shows an example of a related information management table according to the first embodiment.

FIG. 8 shows a processing example of an information control/management server 10 according to the first embodiment.

FIG. 9 shows a processing example of the information control/management server 10 according to the first embodiment.

FIG. 10 shows the configuration of the computer system according to a second embodiment to which the present invention is applied.

FIG. 11 schematically shows a pattern of data update according to the second embodiment.

FIG. 12 shows an example of a version management table according to the second embodiment.

FIG. 13 shows an example of an actual work management table according to the second embodiment.

FIG. 14 shows a display example of guide information displayed on the client device according to the second embodiment.

FIG. 15 shows a processing example of the information control/management server 10 according to the second embodiment.

FIG. 16 shows the configuration of the computer system according to a third embodiment to which the present invention is applied.

FIG. 17 shows an example of an execution user table according to the third embodiment.

FIG. 18 shows an example of a work history list table according to the third embodiment.

FIG. 19 shows an example of a related information table according to the third embodiment.

FIG. 20 shows a display example of guide information and recommendations displayed on the client device according to the third embodiment.

FIG. 21 shows a processing example of the information control/management server 10 according to the third embodiment.

FIG. 22 shows a processing example of the information control/management server 10 according to the third embodiment.

FIG. 23 shows a processing example of the information control/management server 10 according to the third embodiment.

FIG. 24 shows a processing example of the information control/management server 10 according to the third embodiment.

FIG. 25 shows a processing example of the information control/management server 10 according to the third embodiment.

### DESCRIPTION OF EMBODIMENTS

### First Embodiment

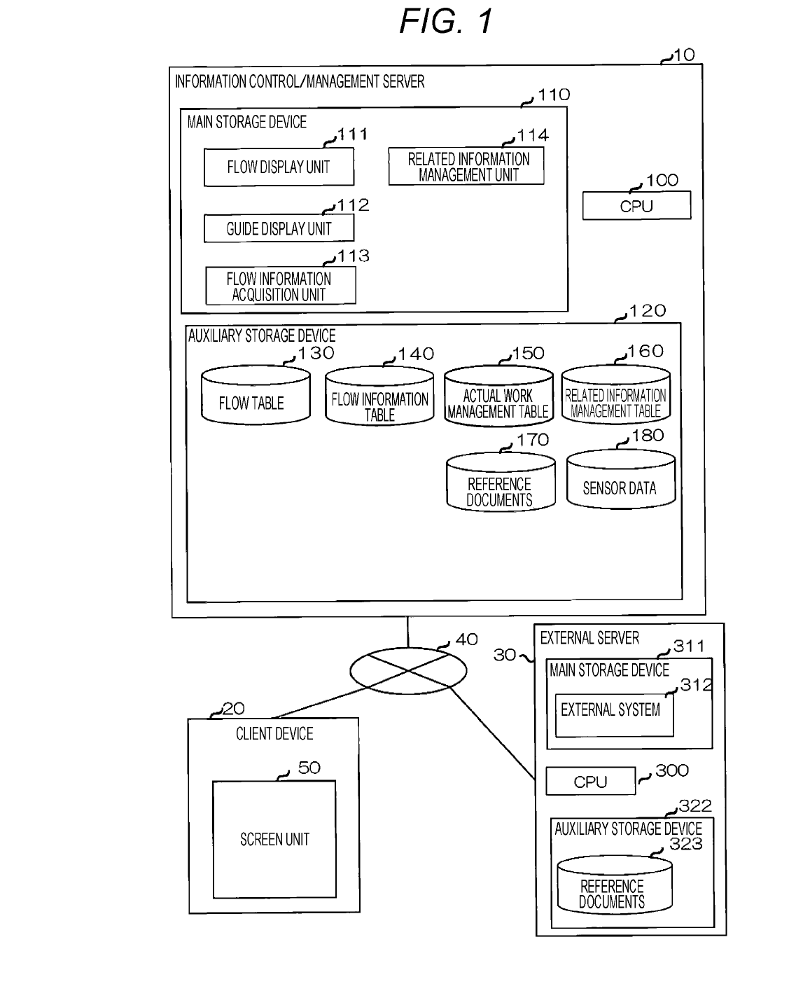

First, an overview of the first embodiment will be provided. FIG. 1 shows the configuration of a computer system to which the present invention is applied. The computer system is formed by the information control/management server 10, a client device 20, and an external server 30 being connected communicably by wire or wirelessly via a communication line 40. In the present embodiment, the computer system can perform predetermined work by receiving a flowchart or the like guiding the flow of the predetermined work and provided by the information control/management server 10 in response to a request of the client device 20 and requesting various kinds of processing from the external server 30 following a work flow chart or the like displayed in a screen unit 50 of the client device 20.

When the client device 20 requests the procedure for “creating an equipment failure analysis report” by a request from the client device 20, the information control/management server 10 transmits flow chart data of the work procedure stored in advance and provides guide information of the work procedure to the screen unit 50 of the client device 20.

Further, by associating and storing work commands (search requests and various directives such as file selection/storage/generation and the like) and data (such as files) used for actual work according to such a flow chart along the flow of processing and then searching for a product (for example, a file as a final product) generated by work up to the last time when the same work is performed, the flow of work such as work commands and files until the product is generated is displayed on the client device 20 so as to be used as a reference for the work this time.

That is, the operation itself of the last operator like actual work commands and the flow of a product generated in accordance with the operation can be provided to the operator this time. If, for example, the last operator is a skilled person in the predetermined work and the operator this time is a novice, an effect of being able to perform work this time by referring to actual work know-how of the skilled person can be expected when the novice performs the same work.

The present embodiment will be described by taking a computer system that supports creation work of various procedures and reports needed when equipment inspections and the like are conducted in facilities like factories, plants, power plants and the like as an example. Being able to share actual work know-how (such as work commands and the order of procedures) in an environment including the above case and becoming more complex with so-called big data in recent years is considered to substantially contribute to utilization of data.

Hereinafter, a computer system will be described in detail.

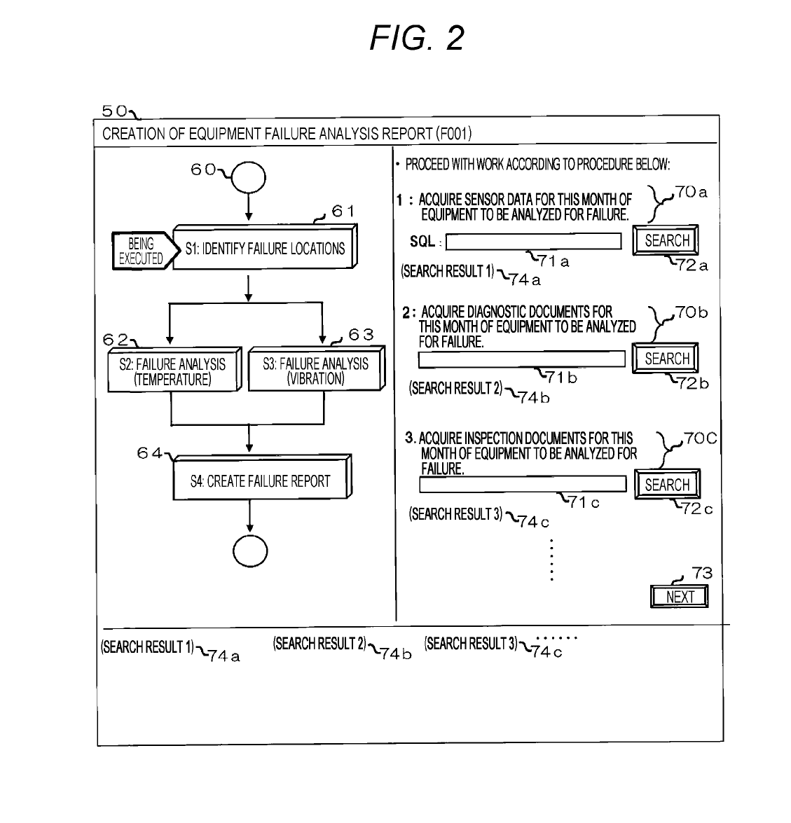

FIG. 2 schematically illustrates a guide screen displayed in the screen unit 50 of the client device 20 in “failure analysis report creation” work. In FIG. 2, a flow chart 60 of the work procedure for “Creation of equipment failure analysis report” is displayed on the left side of the screen. The flow chart 60 includes four steps of nodes 61 to 64. To create an “equipment failure analysis report”, following the procedure for “identifying failure locations” and conducting a “failure analysis (temperature)” and a “failure analysis (vibration)” and then creating a “failure analysis report” can clearly be grasped.

On the right side of the failure analysis screen, the guide to support more detailed steps needed for processing of each of the nodes 61 to 64 and a search screen are displayed. This area is switched to an operation screen (for example, a search screen) needed for work of each node by a node of the flow chart 60 displayed in the screen unit 50 being selected (an arrow of “Being executed” in FIG. 2 signifies the selection) by a user's operation. In FIG. 2, an example of the guide and the search screen displayed when “identifying failure locations” of the node 61 is selected is shown (an arrow of “Being executed” in FIG. 2 signifies the selection).

As a step of identifying a failure location, the node 61 needs to acquire sensor data and also acquire documents of diagnostic and inspection documents of equipment to be analyzed. Following a guide 70a, the operator inputs SQL specifying the target period of sensor data to be acquired into an input field 71a and operates a search button 72a to be able to acquire a link to sensor data of the target period in an area of a “search result 1” 74a in a CSV file name or the like. Similarly, links to diagnostic and inspection documents can be acquired. If, after each step of the node 61 is completed, the node 62 is selected by a user's operation, the right side of the screen is also switched to the step guide and the operation screen related to “S2: Failure analysis (temperature)”.

Also in an area at the bottom of the screen, work results (for example, search results) executed in each step of a node are displayed. Further, in the present embodiment, when switched from steps of the node 61 to steps of the node 62, results such as a “search result 1” 74a, a “search result 2” 74b, and a “search result 3” 74c will continue to be displayed. That is, results are displayed extending over nodes. Also, an effect of being able to proceed with work in consideration of relevance to work this time while referring to results of previous or subsequent steps can be expected.

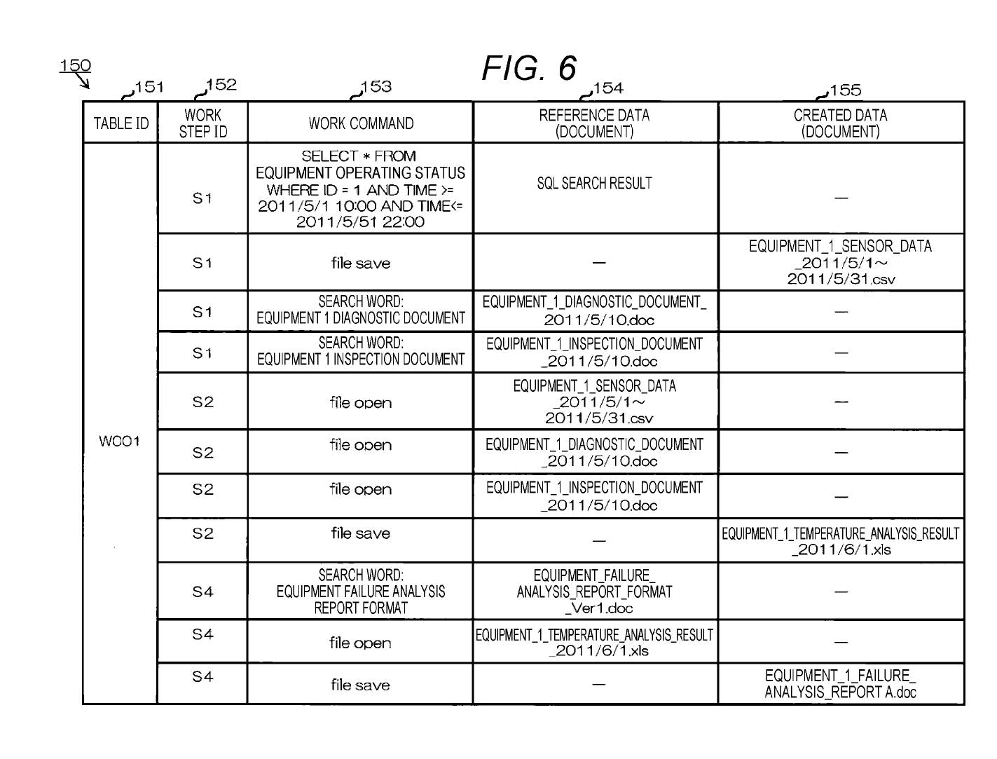

Then, in the work following the flowchart 60, these work commands and results are recorded like an actual work management table 150 (FIG. 6).

Next, a case when information of the actual work management table 150 recorded during the last work is used will be described.

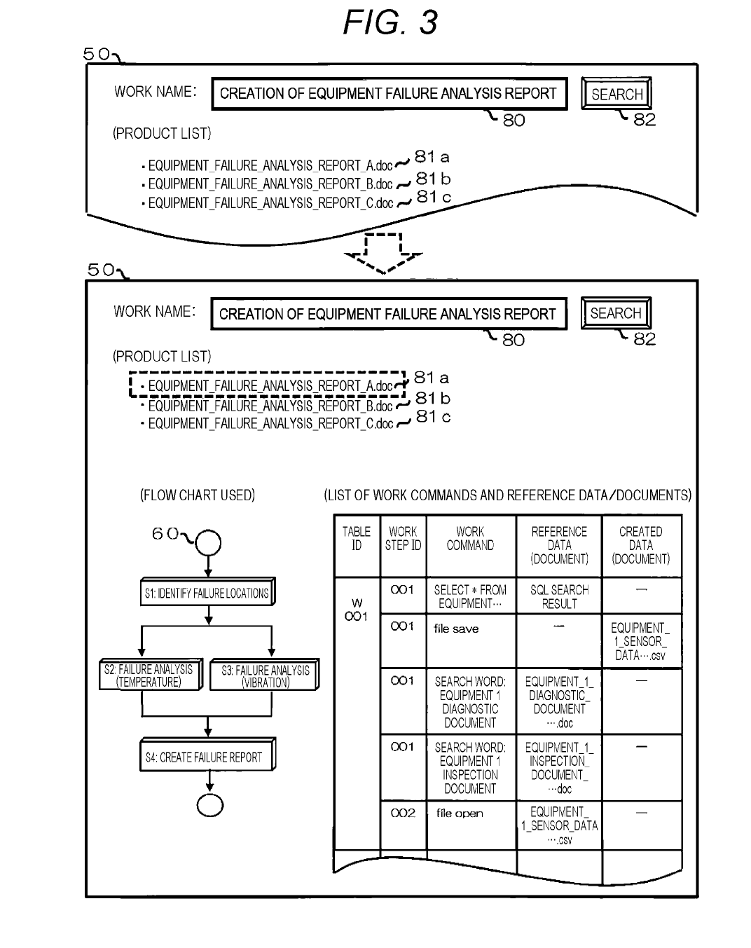

FIG. 3 schematically illustrates a work related information screen displayed on the client device 20 when content of the last work is used. The upper part is a screen portion to invoke recorded work content. When a work name is entered in an input field 80 and a search button 82 is operated, the information control/management server 10 displays a list of product names 81a to 81c (file names of “equipment failure analysis reports A to C”) generated by past work of the work name.

Moving to the lower part of the screen, if the product name 81a (“Equipment_failure_analysis_report_A.doc”) desired by the user is specified, the information control/management server 10 is to display and provide the flow chart 60 used for the work and a “list of work commands and reference data/documents” recording work commands issued during the work and results thereof in the order of process to the client device 20.

Hereinafter, the configuration of a computer system realizing such processing will be described in detail.

In FIG. 1, a main storage device 110 of the information control/management server is provided with a flow display unit 111, a guide display unit 112, a flow information acquisition unit 113, and a related information management unit 114 as function units due to cooperation between a CPU 100 and a program.

The flow display unit 111 is a function unit that causes the screen unit 50 of the client device 20 to display a flow chart. The flow display unit reads flow chart data (not shown) for each piece of work stored in an auxiliary storage 120 or the like in advance transmits the flow chart data to the client device 20 or the like.

The guide display unit 112 displays, as shown, for example, in FIG. 2 or 3, operation guidance in each step (61 to 64) constituting the flow chart 60.

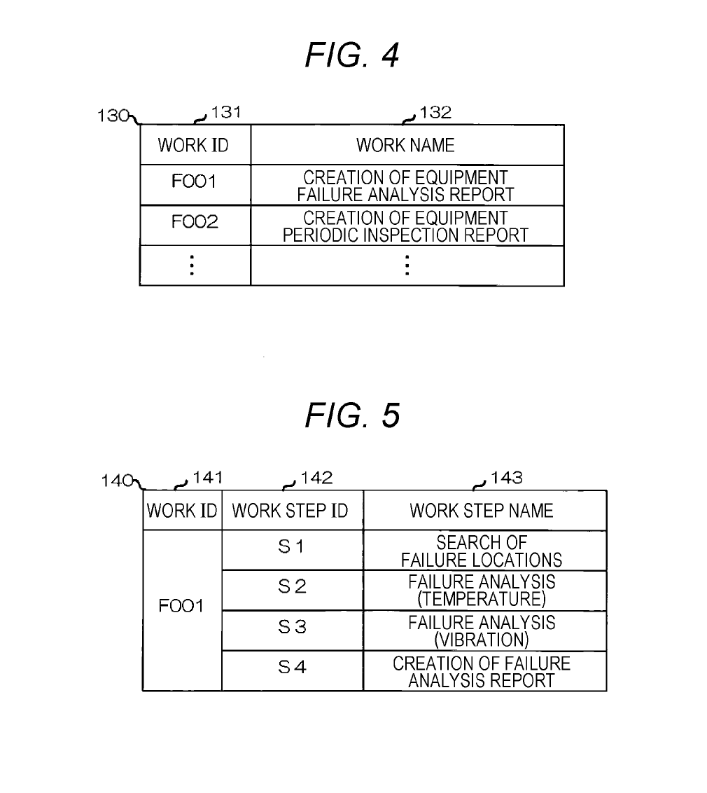

The flow information acquisition unit 113 manages a flow table 130 (FIG. 4) and a flow information table 140 (FIG. 5). The flow information acquisition unit also receives a flow name selected from the client device 20 to acquire the work ID and work step names corresponding to the flow from the flow table 130 and the flow information table 140.

The related information management unit 114 is a function unit that manages by associating work commands issued in each node to execute various steps in each node and processing results by such commands in the order of execution. In normal work, a work command issued from the client device 20 and a result thereof are recorded and the actual work management table 150 (FIG. 6) described later is generated and when work commands and results thereof in past work are referred to, the product of work is specified by the client device 20 and content of the actual work management table 150 is provided to the client device 20.

In the auxiliary storage device 120, the flow table 130, the flow information table 140, the actual work table 150, a related information management table 160, reference documents 170, and sensor data 180 are stored.

In the flow table 130, the ID of a flow chart corresponding to each piece of work and the work name thereof are associated and stored.

FIG. 4 shows an example of the flow table 130. The flow table 130 has items of a work ID 131 and a work name 132.

In the flow information table 140, various steps (nodes) constituting the flow of each piece of work and steps names thereof are associated and managed.

FIG. 5 shows an example of the flow information table 140. The flow information table 140 has items of, for each work ID 141, work step IDs 142 and work step names 142 constituting the work ID. In the present embodiment, for the work whose work ID 141 is “F001”, work node (step) names of “Search of failure locations”, “Failure analysis (temperature)”, “Failure analysis (vibration)”, and “Creation of failure analysis report” are defined as the work step names 142 for the work step IDs 142 “S1 to S4” respectively.

The work ID 141 corresponds to the work ID of the above flow table 130.

In the actual work management table 150, when the user actually performs work along the work flow chart 60, the work command operated via the client device 20 and a result of processing performed with the external server 30 in accordance with content of the operation are associated and managed. A result of processing performed with the external server 30 is, if the work command from the client device 20 is a search request, a search result (including a list) transmitted in response thereto and, if the work command is a reference command of a predetermined file, the file is recorded by associating the file name thereof.

FIG. 6 shows an example of the actual work management table 150. The actual work management table 150 has items of a table ID 151, a work step ID 152, a work command 153, reference data 154, and created data 155. The table ID 151 is an ID that identifies execution of work using the work flow chart 60.

The work step ID 152 corresponds to the work step ID 142 of the above flow information table 140.

For example, an actual work table having the table ID of “W001” is provided each time the user performs work following the work flow chart via the client device 20. The work node (step) whose work step ID 152 is “S1” is “Identification of failure locations” and the work command output from the client device 20 in accordance with a user's operation in the step is a SQL statement of “SELECT*FROM Equipment operating status WHERE ID=1 AND TIME>=2011/5/1 10:00 AND TIME<2011/5/31 22:00”. This SQL statement shows an inquiry about “operating status (for example, sensor data) of equipment whose ID is 1 between 10:00 on May 1, 2011 to 22:00 on May 31, 2011”. Then, as a SQL search result, the equipment operating status (sensor data) in the range specified by SQL is recorded in a field of the reference data 153 (details of search results are abbreviated in FIG. 6).

Similarly, in the work node (step) of “Identification of failure locations”, the work command issued by the client device 20 next is “file save” and the input of the work command to the effect that sensor data of the operating status of the equipment 1 acquired previously should be saved is recorded. Then, as a processing result of the work command, a “Equipment_{—}1_sensor_data_{—}2011/5/1_to_{—}2011/5/31.CSV” file is created and the file name “Equipment_l_sensor_data_{—}2011/5/1_to_{—}2011/5/31.csv” is recorded in the field of the created data 154.

FIG. 6 also shows that two work commands whose search words are “Equipment 1 diagnostic document” and “Equipment 1 inspection document” are each issued thereafter in “Identification of failure locations” having the work step ID of “S1” and processing results thereof are recorded in predetermined items.

In the related information management table 160, the product generated in the end after all steps of a work flow chart being executed and information of all or a portion of the flow table 130 (FIG. 4), the flow information table 140 (FIG. 5), and the actual work management table 150 (FIG. 6) are associated and managed.

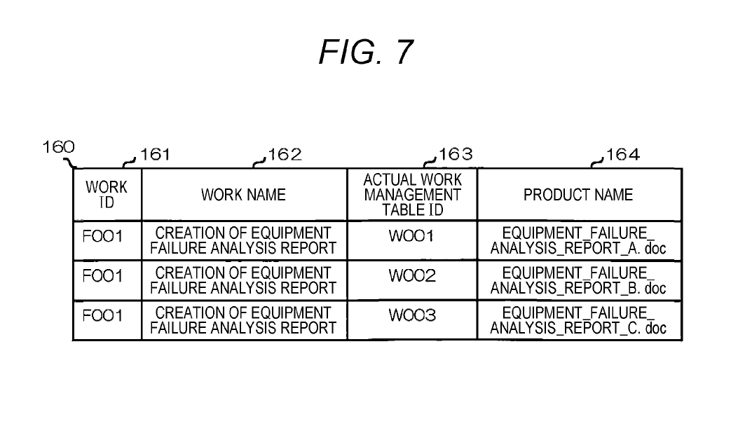

FIG. 7 shows an example of the related information management table 160. The related information management table 160 has items of a work ID 161, a work name 162, an actual work management table ID 163, and a product name 164. The work ID 161 and the work name 162 correspond to the work flow ID and work name of the flow table 130 and the flow information table 140 respectively. The actual work management table ID 163 corresponds to the ID (W001 and the like) of an actual work management table.

For example, FIG. 7 shows that the work ID 161 is “F001”, the work name 162 of “Creation of equipment failure analysis report” corresponds to the actual work management table “W001” and corresponds to a file whose product name 164 is called “Equipment_failure_analysis_report_A.doc” as a product thereof.

Returning to FIG. 1, the reference documents 170 are of the same kind as reference documents 323 described later and stored in the external server 30 and are stored in the auxiliary storage device 120 as the primary storage destination. The sensor data 180 is sensor data collected from various kinds of equipment.

The client device 20 is a computer device in which the CPU, memory and the like are contained and various kinds of terminals such as PCs, mobile terminals and the like are applicable. A mouse, a keyboard, a touch panel, or voice input can be applied as an input means. In addition, an output interface may be included to make the screen of FIGS. 2 and 3 printable or transmissible to other computers via electronic mail or the like.

The external server 30 includes a CPU 300, a main storage device 311, and an auxiliary storage device 322. The main storage device 311 includes an external system 312 realized by cooperation between the CPU 300 and a program. The external system 312 receives a search command issued by the client device 20 and provides reference documents (for example, data of equipment diagnostic documents and equipment inspection documents needed for work or data of equipment failure analysis reports as a product generated by work) stored in the auxiliary storage device 322.

In the present invention, the computer system is not limited to the above configuration. For example, the client device 20 may be configured as a portion of the information control/management server 10 or the information control/management server 10 and the external server 30 may be configured as virtual servers in the same physical computer.

The flow of processing of a computer system having the above configuration will be described in detail using a flow chart. The following processing is performed by a program being executed by the CPU.

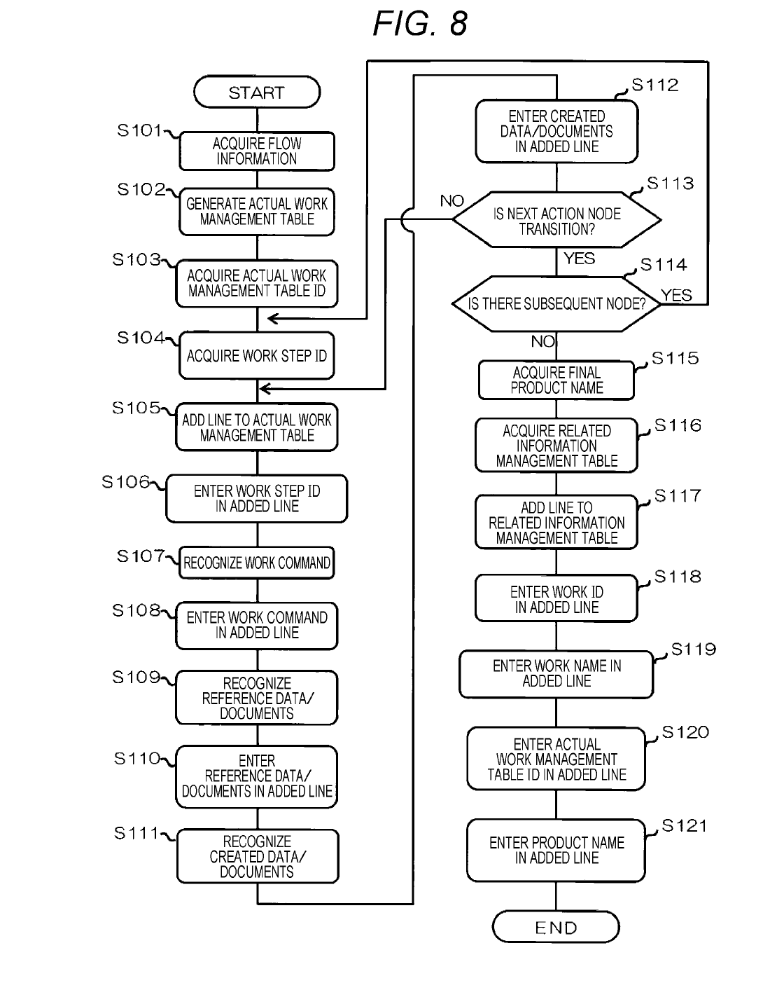

First, processing to record by associating work commands executed and data/documents referred to by the operator during work for each work node (step) will be described using FIG. 8.

In step S101, the CPU 100 refers to the flow table 130 to acquire the work ID 131 and the work name 132 of the flow chart requested by the operator this time via the client device 20.

In step S102, the CPU 100 newly creates the actual work management table 150 and attaches the table ID 151 capable of uniquely identifying the actual work management table 150. This is intended to record work commands issued by the client device 20 and data/documents referred to for work this time.

In step S103, the CPU 100 acquires the table ID 151 attached to the newly created actual work management table 150.

In step S104, the CPU 100 receives a selection directive of a node in the flow chart 60 from the client device 20 and refers to the flow information table 140 (FIG. 5) to acquire the work step ID 142 of the node.

In step S105, the CPU 100 newly adds an empty line to the actual work management table 150.

In step S106, the CPU 100 enters the work step ID 142 acquired in step S104 in the line added to the actual work management table 150.

In step S107, the CPU 100 acquires work commands (SQL, search words, data creation and the like) issued by the client device 20 in processing of the flow chart.

In step S108, the CPU 100 enters the acquired work commands in the line added to the actual work management table 150.

In step S109, the CPU 100 acquires names of data/documents referred to as execution results of the work commands acquired in S107.

In step S110, the CPU 100 enters the names of the acquired data/documents in the line added to the actual work management table 150.

In step Sill, the CPU 100 acquires names of data/documents created as execution results of the work commands executed in S107.

In step S112, the CPU 100 records the names of the acquired data/documents in the line added to the actual work management table 150.

In step S113, the CPU 100 determines whether the next action of the client device 20 is a node transition, instead of issuance of a work command. If the next action is a note transition, the CPU proceeds to S114 (S113: YES). If the next action is issuance of a work command, instead of a note transition, the CPU returns to S104 (S113: NO).

In step S114, the CPU 100 determines whether there is a subsequent node. If there is a subsequent node, the CPU returns to S104 (S114: YES). If there is no subsequent node, the CPU proceeds to S115 (S114: NO).

In step S115, the CPU 100 stores the name of the data/document acquired last in the main storage device 110.

In step S116, the CPU 100 acquires the related information management table 160 and adds a new line thereto (S117).

In step S118, the CPU 100 enters the work ID 131 of the flow chart 60 acquired in S101 in the added line. Next, in step S119, the CPU enters the work name of the flow chart 60 acquired in S101 in the added line.

In step S120, the CPU 100 enters the table ID 151 of the actual work management table 150 acquired in S103 to the added line.

In step S121, the CPU 100 enters the product name acquired in S215 in the added line.

With the above processing, work commands and execution results or the execution order thereof in the work performed by the operator along the flow chart 60 can be associated and recorded. That is, it becomes possible to create the actual work management table 150 shown in FIG. 6 and further associate the table with a product.

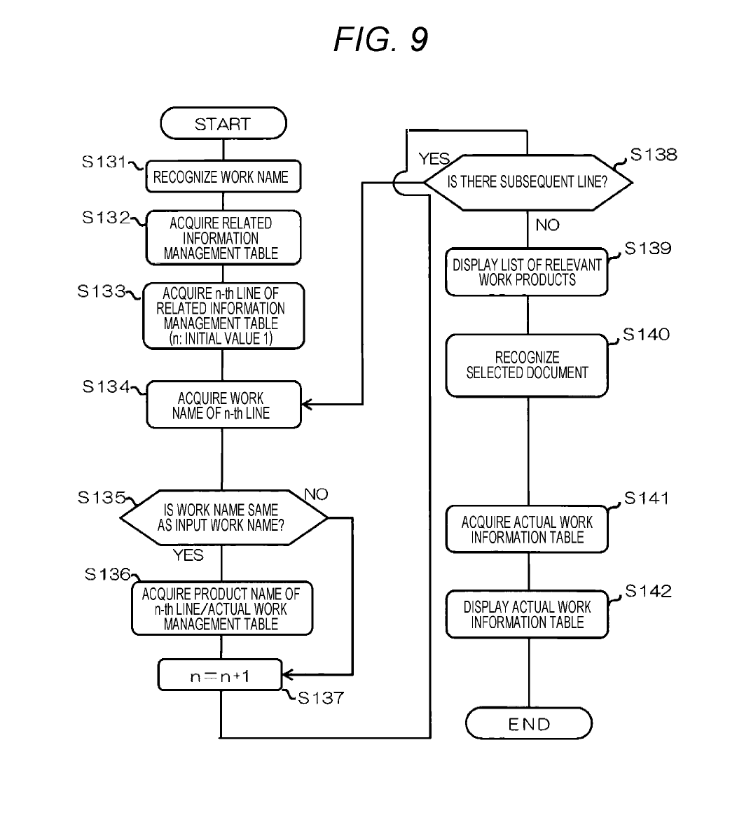

Next, processing to display content recorded by the processing in FIG. 8 on the client device 20 will be described using FIG. 9. More specifically, the processing is processing to provide information shown in FIG. 3 in response to a request from the client device 20.

In step S131, the CPU 100 acquires the work name (for example, “Creation of equipment failure analysis report”) entered by the user in the input field 80 displayed on the client device 20.

In step S132, the CPU 100 acquires the related information management table 160 (FIG. 7).

In step S133, the CPU 100 refers to the n-th line (n: initial value 1) of the related information management table 160 and, in step S134, acquires the work name of the n-th line.

In step S135, the CPU 100 determines whether the acquired work name of the n-th line matches the work name transmitted from the client device 20 in S131. If both work names match, the CPU proceeds to S136 (S135: YES) and if both work names do not match, the CPU proceeds to S137 (S135: NO)

In step S136, the CPU 100 acquires the product name 164 and the actual work management table ID 163 of the n-th line of the related information management table 160.

In step S137, the CPU 100 increments the line number n to be referred to in the related information management table 160 by 1 before returning to S134.

In step S138, the CPU 100 determines whether there is a subsequent line in the related information management table 160. If there is a subsequent line, the CPU returns to S134 and if there is no subsequent line, the CPU proceeds to S139.

In step S139, the CPU 100 provides a list of the acquired product names 81a to 81c to the client device 20.

In step S140, the CPU 100 acquires the product selected by the user from the list of products from the client device 20.

In step S141, the CPU 100 acquires the actual work management table 150 based on the actual work management table ID corresponding to the acquired product name.

In step S142, the CPU 100 identifies the acquired actual work management table 150 and the corresponding flow chart by using the work ID of the related information management table 160 and transmits the above information to the client device 20.

With the above processing, information as shown in FIG. 3 can be provided to the client device 20.

According to the first embodiment described above, content of performed work can be provided in greater detail. Accordingly, effects of checking or improving reliability of work and using to give instruction in know-how can be expected.

### Second Embodiment

In a computer system according to the first embodiment, reference data/documents referred to during work is frequently updated when appropriate. In the above example, for example, when an equipment failure analysis report is created, versions of data/documents to be referred to in each work node (step) may be old due to revision of a law or changes of various rules. In the second embodiment, even if such an update of reference data/documents occurs, the previous flow of work is enabled to use while the operator takes such an update into consideration.

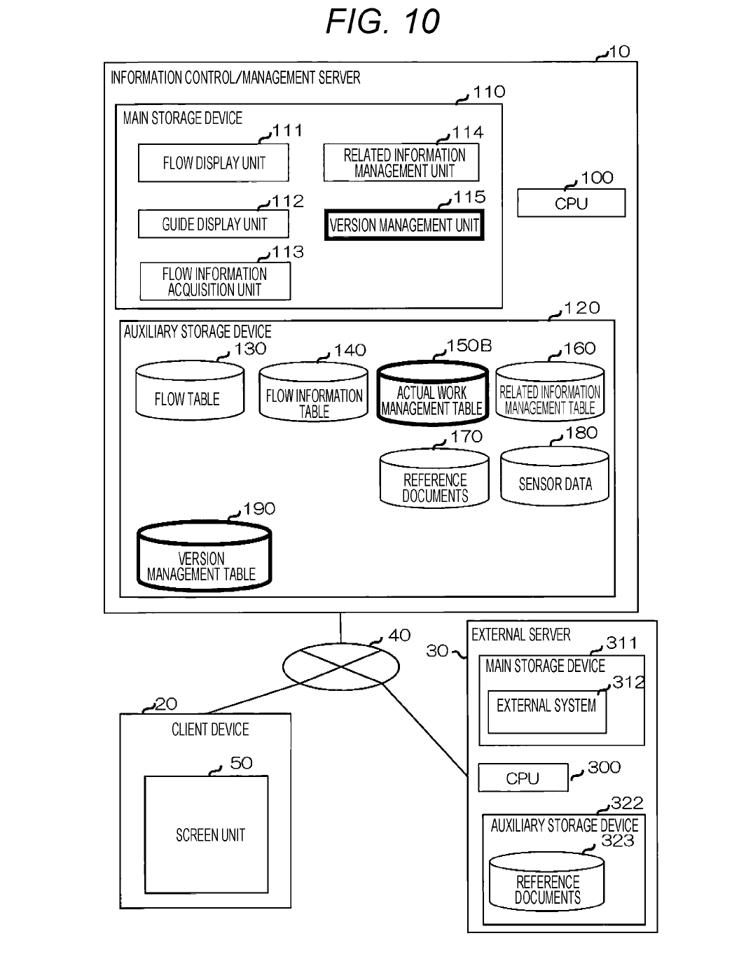

FIG. 10 shows the configuration of the computer system according to the second embodiment. The computer system according to the second embodiment is different from that according to the first embodiment in that the information control/management server 10 includes a version management unit 115 and a version management table 190 and also includes an actual work management table 150B to which information about updated reference data is added.

The version management unit 115 is a function unit that manages to see whether reference data is updated and is realized by cooperation between a program and the CPU 100. Roughly two patterns can be considered for an update of reference data.

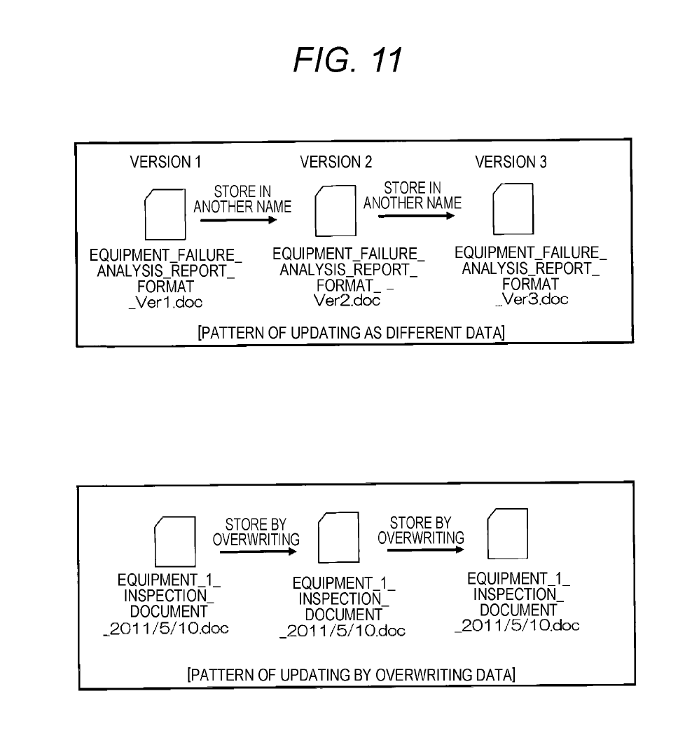

One pattern is a case in which, as shown in FIG. 11, a version update occurs between different data. More specifically, this is a case in which when reference data is updated, the data is stored by changing the file name. This is a case in which, for example, reference data whose file name is initially
“Equipment_failure_analysis_report_format_Ver1.doc” is stored under the file name
“Equipment_failure_analysis_report_format_Ver3.doc” after an update. The other pattern is a case in which an update is stored by overwriting and the file name is not changed.

When a save command to reference data is detected, the version management unit 115 associates and enters information about the update data in a corresponding field of the actual work management table 150B as the latest reference data.

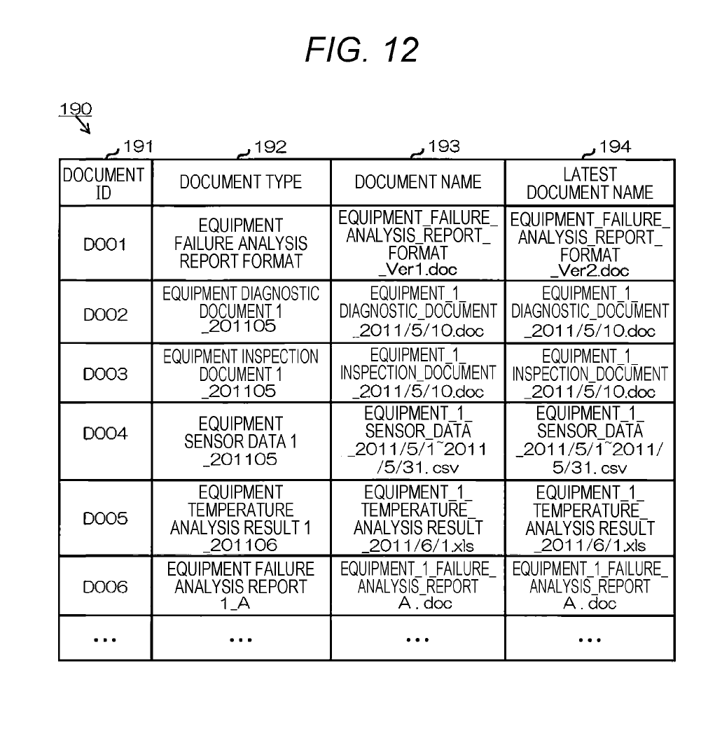

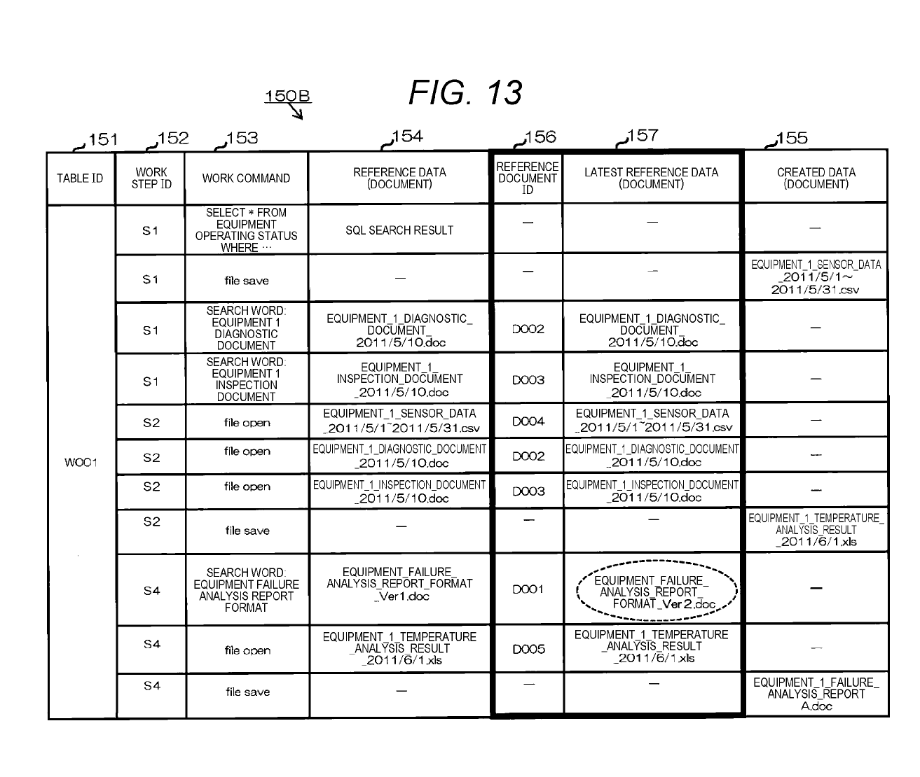

FIG. 12 schematically shows the version management table 190. The version management table 190 has items of a document ID 191, a document type 192, a document name 193, and a latest document name 194.

The document ID 191 is a unique ID held by a document. The document type 192 is a unique type name representing categorization of documents. The document name 193 is a unique name held by a document present in a one-to-one correspondence with the document ID 191. The latest document 194 is the name of the latest document among a plurality of documents belonging to the document type name 192.

In FIG. 12, the document updated by changing its file name is a document whose document type is “Equipment failure analysis report format”. Here, the document name 193 is “Ver1.doc” before the update and the latest document name 194 after the update is entered as “Ver2.doc”. Other documents are updated by overwriting. That is, only one piece of document data is present at some point in time and thus, the document name 193 and the latest document name 194 are the same name. Because the version management table 190 is entered when a document is updated, an occurrence of update can be known with an entry in the version management table 190 even for an update by overwriting.

The content of the version management table 190 in FIG. 12 is also reflected in the actual work management table 150B. Therefore, the user can also know that a reference document referred to in past work is thereafter updated.

FIG. 13 schematically shows the actual work management table 150B. The actual work management table 150B is different from the actual work management table 150 in the first embodiment is that a reference document ID 156 and latest reference data 157 are included.

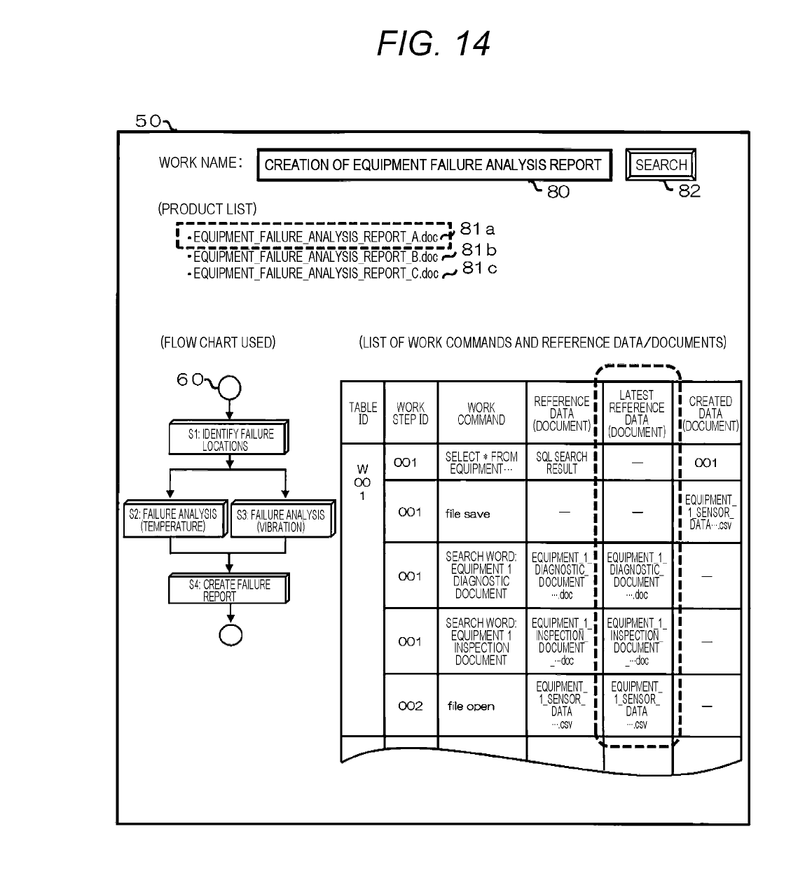

The content of the actual work management table 150B managed as described above is provided to the client device 20. FIG. 14 shows a display example of the screen unit 50 of the client device 20. An item of “Latest reference data/document” is added to the area of “List of work commands and reference data/documents” and the reference data/document name after the update is displayed side by side with the name before the update.

Hereinafter, the flow of operation according to the second embodiment will be described.

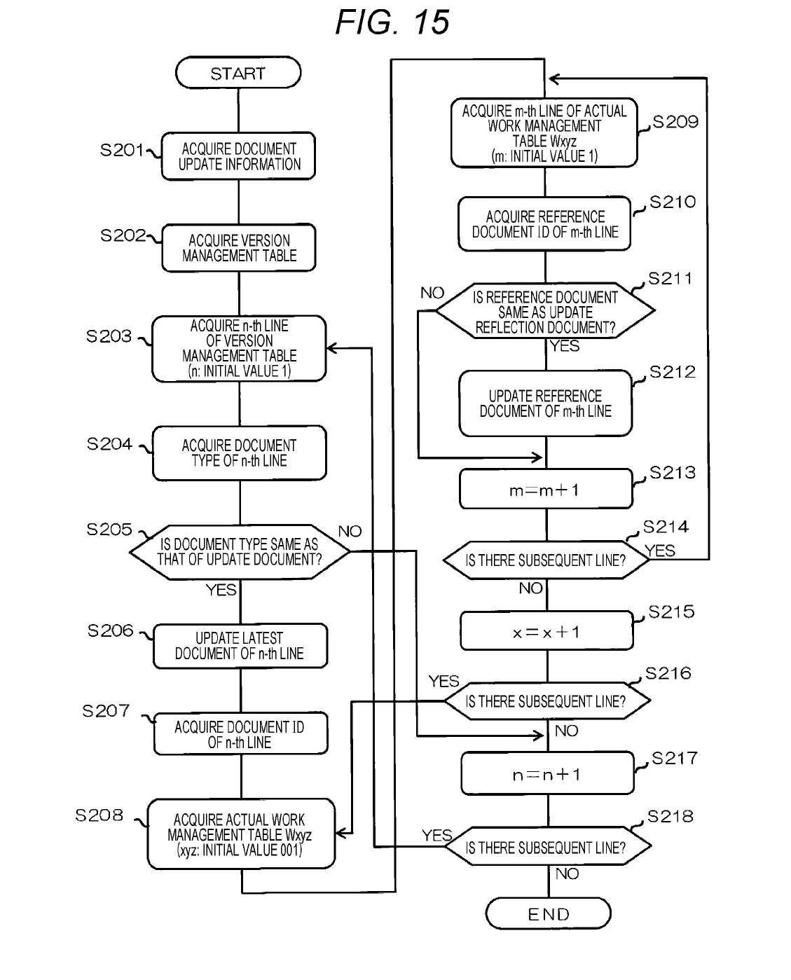

FIG. 15 shows the flow of reflecting a version update arising in reference data/documents in the actual work management table 150B.

In step S201, the CPU 100 acquires information about the document (the document name and the document type) whose version is updated from the version management unit 115 or a version management system provided outside.

In step S202, the CPU 100 acquires the version management table 190.

In step S203, the CPU 100 acquires the n-th line (n: initial value 1) of the version management table 190 acquired in S202.

In step S204, the CPU 100 acquires the document type 192 of the n-th line acquired in S203.

In step S205, the CPU 100 determines whether the document type acquired in S204 matches that of the version updated document acquired in S201. If both document types match, the CPU proceeds to S206 and if both document types do not match, the CPU proceeds to S217.

In step S206, the CPU 100 updates (overwrites) the latest document name 194 of the n-th line acquired in S203 with the document name 192 of the version updated document acquired in S201.

In step S207, the CPU 100 acquires the document ID 191 of the n-th line acquired in S203.

In step S208, the CPU 100 acquires an actual work management table 150B_Wxyz (xyz: initial value 001).

In step S209, the CPU 100 acquires the m-th line (m: initial value 1) of the actual work management table 150B_Wxyz acquired in S208.

In step S210, the CPU 100 acquires the document ID 156 of the m-th line of the actual work management table 150B_Wxyz acquired in S209.

In step S211, the CPI 100 checks whether the document ID of the m-th line of the actual work management table 150B_Wxyz acquired in S210 matches that of the n-th line of the version management table 190 acquired in S207. If both document IDs match, the CPU proceeds to S212 and if both document IDs do not match, the CPU proceeds to S213.

In step S212, the CPU 100 updates (overwrites) the latest reference document of the m-th line of the actual work management table 150B_Wxyz acquired in S209 with the document name of the version updated document acquired in S201.

In step S213, the CPU 100 increments the line number m acquired in S209 in the actual work management table 150B_Wxyz by 1.

In step S214, the CPU 100 determines whether the line number m set in S213 is present in the actual work management table 150B_Wxyz acquired in S208. If the number m is present, the CPU proceeds to S215 and if the number m is not present, the CPU returns to S209.

In step S215, the CPU 100 increments a table number xyz of the actual work management table 150B_Wxyz acquired in S208 by 1.

In step S216, the CPU 100 determines whether the table number xyz set in S215 is present in the actual work management table 150B acquired in S208. If the table number is present, the CPU returns to S208 and if the table number is not present, the CPU proceeds to S217.

In step S217, the CPU 100 increments the line number n acquired in S203 in the version management table 190 by 1.

In step S218, the CPU 100 determines whether the table number n set in S217 is present in the version management table 190 acquired in S202. If the table number is present, the CPU returns to S203 and if the table number is not present, the CPU terminates the processing.

With the above processing, updated reference data/documents can be reflected in the actual work management table 150B. Accordingly, guidance as shown in FIG. 14 can be provided in response to a request from the client device 20.

When the relationship between work commands and results for creating a past product is grasped, by associating and providing names of reference data/documents updated thereafter, attention of the operator can be called to use update data this time to proceed with work and also, such data can effectively be used to verify that content of the past product is based on reference data before the updates.

### Third Embodiment

One feature of the third embodiment is that information to recommend appropriate work commands and reference data/documents for each work node (step) on the guide screen is provided to the client device 20 by using the actual work management table 150 or 150B obtained in the first or second embodiment. That is, if a plurality of operators has performed the same work in the past, a case in which a plurality of sets of work commands issued by each work node (step), results thereof, and the execution order is present can be considered.

In the third embodiment, recommendation content is decided by fitting to the operator who has performed the relevant work most frequently.

Hereinafter, the third embodiment will be described in detail. In the present embodiment, in contrast to the first and second embodiments, a case in which “Creation of equipment failure action report” is performed as work is taken as an example.

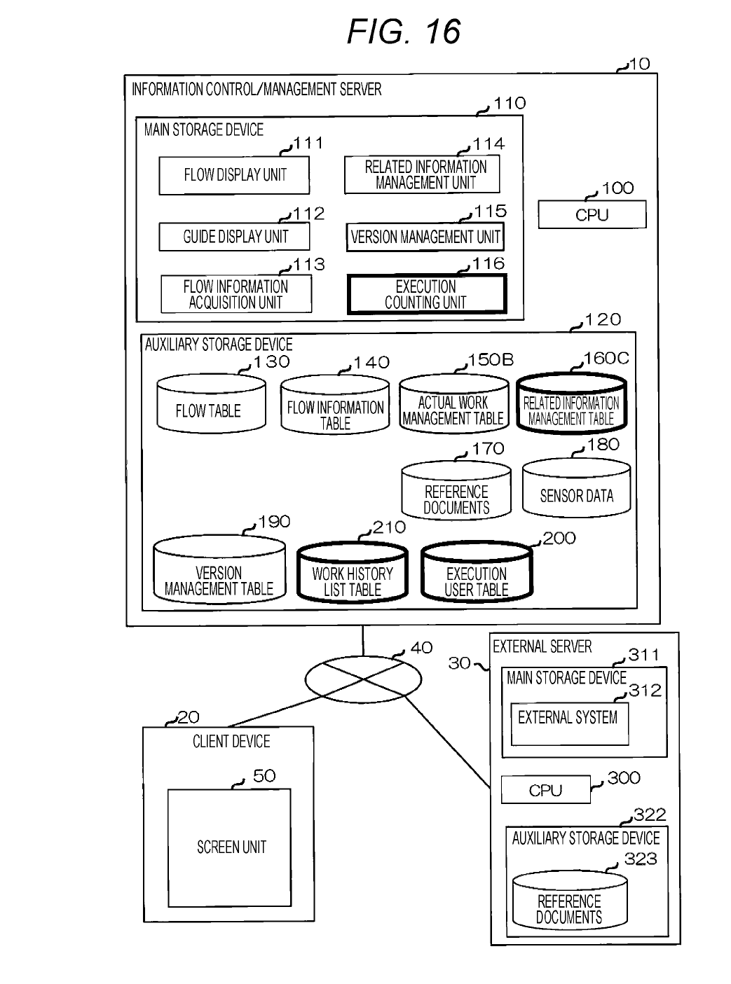

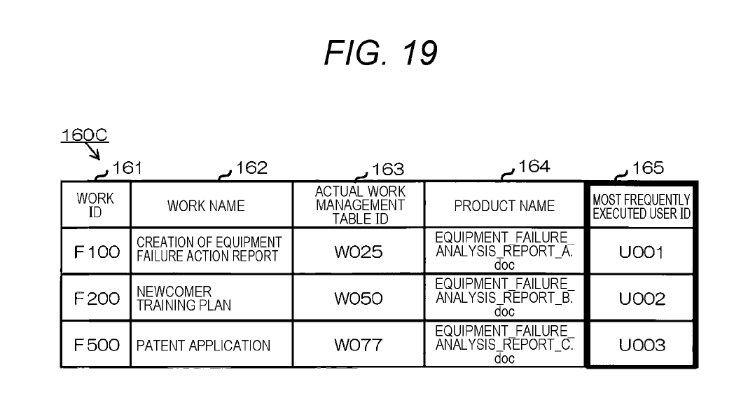

FIG. 16 shows the configuration of the computer system according to the third embodiment. The third computer system newly includes an execution counting unit 116, an executing user table 200, and a work history list table 210 on the information control/management server 10. In addition, an item of a most frequently executed user ID 165 (FIG. 19) is newly added to a related information management table 160C.

The execution counting unit 116 is a function unit that manages and records in the executing user table 200 the work name, the user ID, the execution count, and the latest history work ID for each piece of work performed by the operator. In addition, each time work is performed by the computer system, a work history ID 211, a work ID 212, a user ID 213, and an actual work management table ID 214 are recorded in the work history list table 210.

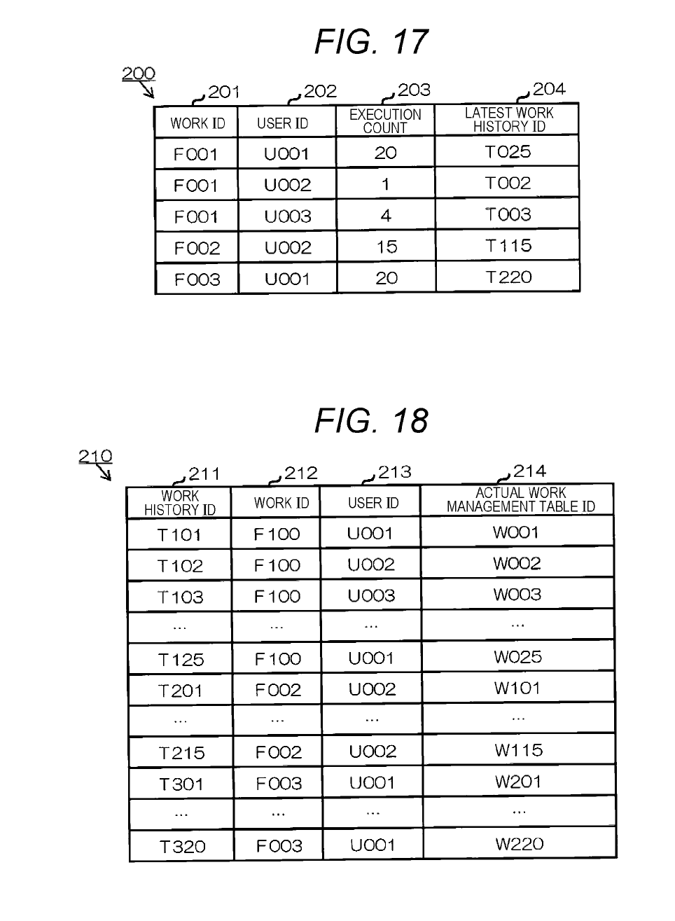

FIG. 17 schematically shows the executing user table 200, FIG. 18 shows the work history list table 210, and FIG. 19 shows the related information management table 160C.

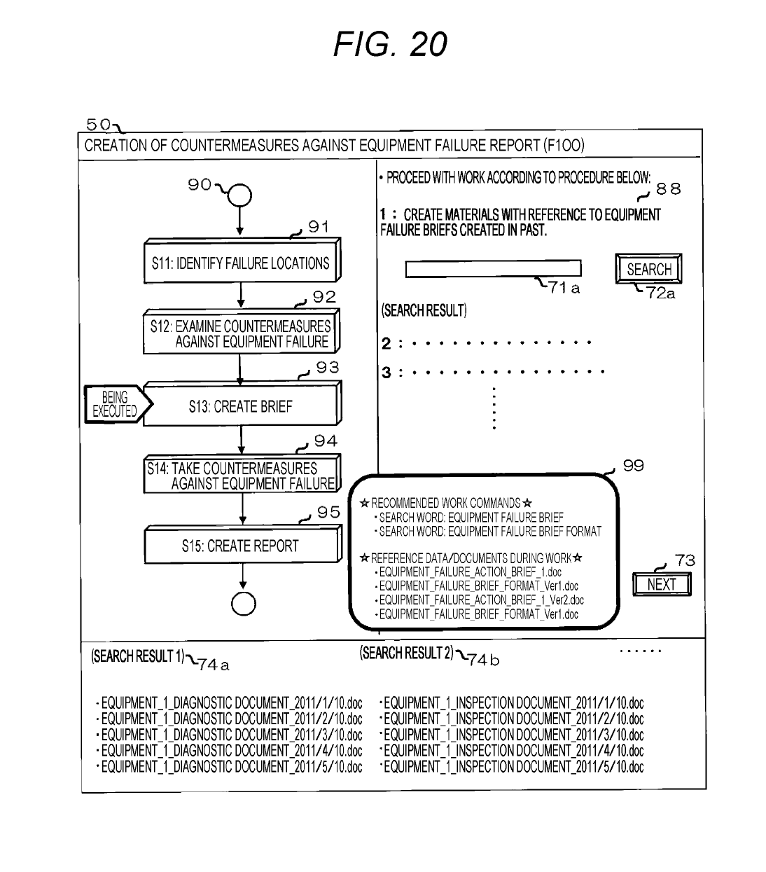

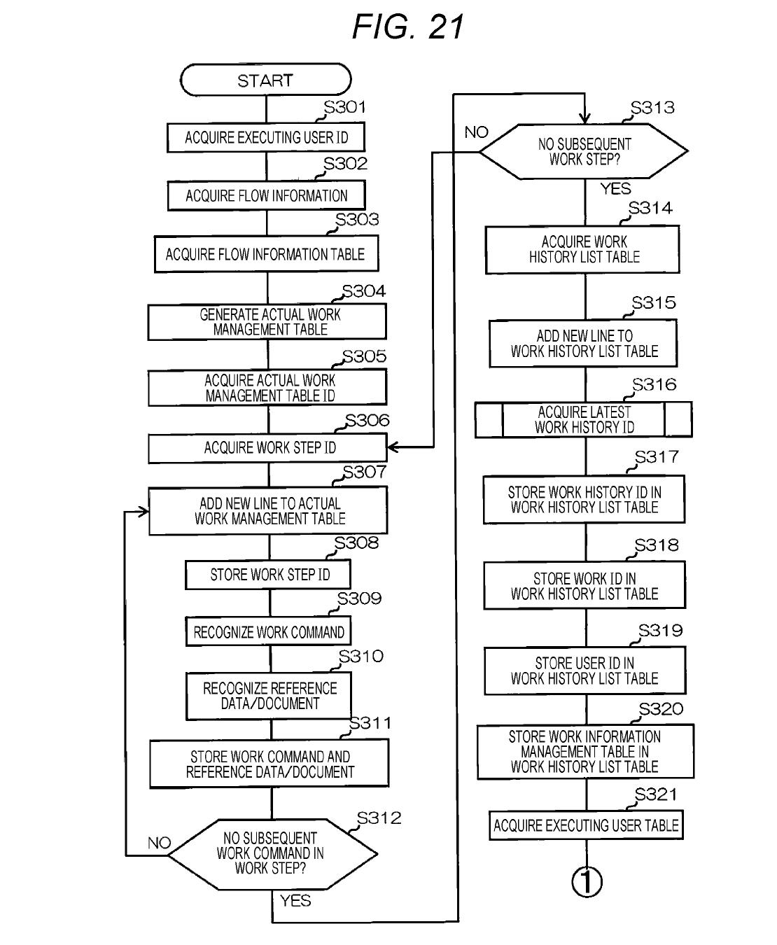

FIG. 20 schematically illustrates the guide screen displayed in the screen unit 50 of the client device 20 when “Creation of equipment failure action report” is performed in the present embodiment.

On the left side of the screen, a flow chart 90 showing the flow of the work “Creation of equipment failure action report” is shown. The flow chart 90 includes five work nodes (steps). FIG. 20 shows a state in which the work node (step) of “Create brief” is currently selected by a user's operation in the client device 20.

On the right side of the screen, a guide 88 provided in the work node (step) of “Create brief”, an input field 71a, a search button 72a and the like are displayed. Only the one guide 88 is illustrated as an example, but as outlined in FIG. 20, a plurality of guides can also be displayed. When the number of guides is large, only the present area can be displayed by causing a transition through a button 73.

In the lower portion of the screen, results of search work performed in previous work nodes (steps) are displayed. Like other embodiments, results can be displayed by extending over work nodes (steps).

In recommendations 99 in the center of the screen, work commands and reference data/documents recommended to the operator this time for the work node (“S13: Create brief”) and the latest update content when the reference data/documents have been updated are displayed. In the present embodiment, when a “Create brief” node 83 is selected by a user's operation, the recommendations 99 are displayed as a popup window.

Work commands and reference data/documents recommended in the recommendations 99 are those having many elements common to work records of past operators by using the work history list table 210. In the present embodiment, work commands executed by the most numerous operators and reference data/documents during work are displayed, but the present invention is not limited to such an example.

Next, the operation of a computer system according to the third embodiment will be described.

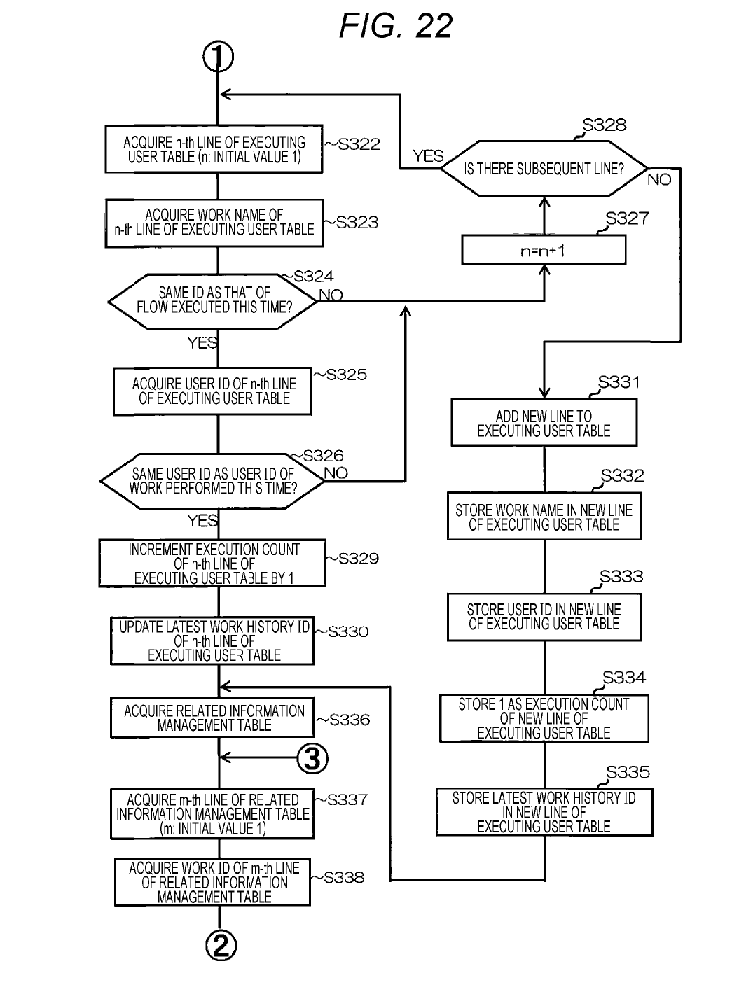

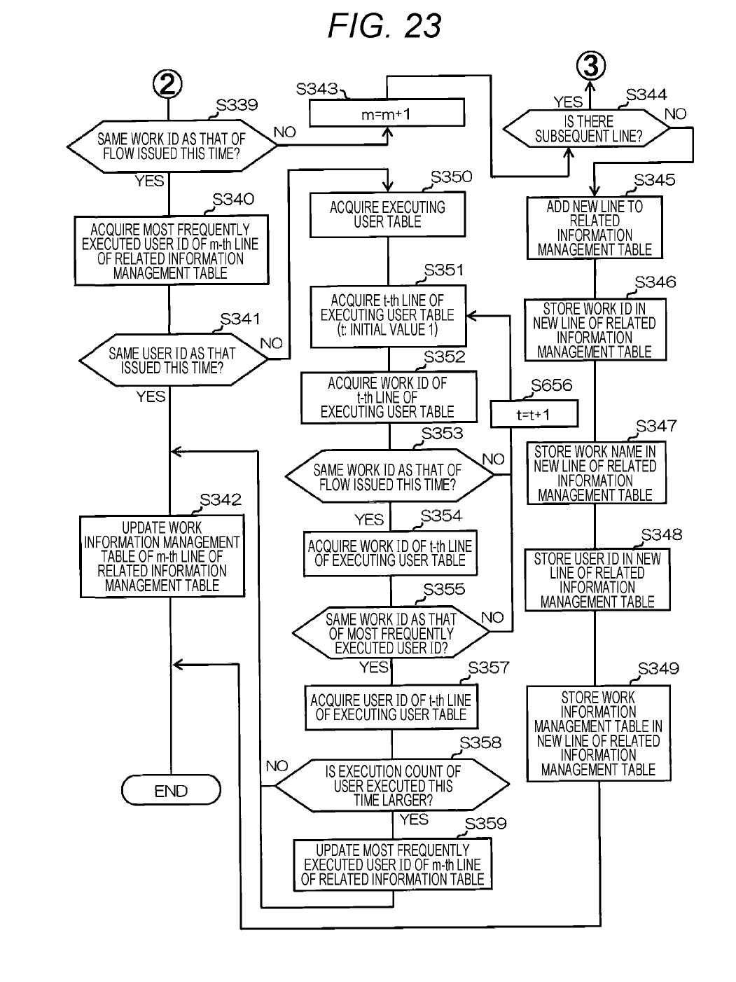

FIGS. 21 to 23 are a processing flow of storing by associating each work node (step) and work commands and reference data/documents there in work when the operator performs the work using the flow chart 90 shown in FIG. 20 and also storing the execution count of the operator of the relevant work until now.

In step S301, the CPU 100 acquires the user ID of the operator who performs work this time. Authentication information acquired via the client device 20 when the computer system is used or the like is used.

In step S302, the CPU 100 refers to the flow table 130 to acquire the work ID 131 and the work name 132 of the flow chart 90 executed by the operator this time.

In step S303, the CPU 100 acquires the flow information table 140 matching the work ID 131 from the work ID 131 acquired in S302.

In step S304, the CPU 100 generates the actual work management table 150B to store work commands executed by the operator for the work this time and data/documents referred to this time.

In step S305, the CPU 100 acquires the table ID 151 of the actual work management table 150B generated in S604.

In step S306, the CPU 100 acquires the work step ID selected in the flow chart 90.

In step S307, the CPU 100 newly adds a new line to the end of the actual work management table 150B generated in S304.

In step S308, the CPU 100 enters the work step ID 142 acquired in S306 in the work step ID 152 of the line newly added to the actual work management table 150B.

In step S309, the CPU 100 acquires the work command (such as a search word, SQL or so) issued by the client device 20 following an operation of the operator.

In step S310, the CPU 100 acquires data/document names referred to as a result of executing the work command.

In step S311, the CPU 100 enters the acquired work command and reference data/documents as a result of execution thereof in the work command 153 and the reference data/documents 154 in the line generated in S307.

In step S312, the CPU 100 determines whether the next action of the client device 20 is a node transition, instead of issuance of a work command. If the next action is issuance of a work command, the CPU proceeds to S307 and if the next action is a node transition, the CPU returns to S313.

In step S313, the CPU 100 determines whether there is still a node after the node (step) acquired in S306. If there is still a node, the CPU proceeds to S306 and if there is no node, the CPU proceeds to S314.

In step S314, the CPU 100 acquires the work history list table 210.

In step S315, the CPU 100 adds a new line to the end of the acquired work history list table 210.

In step S316, the CPU 100 acquires the work with the largest (latest) work history ID of the corresponding work (work name acquired in S302) from the work history list table 210.

In step S317, the CPU 100 enters the work history ID value larger than the value acquired in S316 by 1 in the work history ID 211 of the new line created in S315 of the work history list table 210.

In step S318, the CPU 100 records the work ID 131 acquired in S602 of the flow chart 90 in a work ID 202 of the new line created in S315 of the work history list table 210.

In step S319, the CPU 100 records the user ID acquired in S301 in the user ID 213 of the new line created in S315 of the work history list table 210.

In step S320, the CPU 100 records the table ID acquired in S305 of the actual work management table 150B in the actual work management table ID 214 of the new line created in S315 of the work history list table 210.

In step S321, the CPU 100 acquires the executing user table 200.

In step S322, the CPU 100 acquires the n-th line (n: initial value 1) of the executing user table 200 acquired in S621.

In step S323, the CPU 100 acquires the work ID of the n-th line acquired in S322.

In step S324, the CPU 100 checks whether the work ID of the n-th line acquired in S323 matches the work ID acquired in S302 of the flow chart 90. If both work IDs match, the CPU proceeds to S325 and if both work IDs do not match, the CPU proceeds to S327.

In step S325, the CPU 100 acquires the user ID of the n-th line acquired in S322 of the executing user table 200.

In step S326, the CPU 100 determines whether the user ID acquired in S325 of the n-th line matches the user ID acquired in S301. If both user IDs match, the CPU proceeds to S329 and if both user IDs do not match, the CPU proceeds to S327.

In step S327, the CPU 100 increments the line number n acquired in S322 in the executing user table 200 by 1.

In step S328, the CPU 100 determines whether the line number n set in S327 is present in the executing user table 200 acquired in S321. If the line number is present, the CPU returns to S322 and if the line number is not present, the CPU proceeds to S331.

In step S329, the CPU 100 acquires the value of execution count of the n-th line acquired in S322 of the executing user table 200 and newly records (overwrites) a value larger than the value of execution count by 1.

Step S330 records (overwrites) a value larger than the work history ID acquired in S316 by 1 in a latest work history ID 204 of the n-th line acquired in S322 of the executing user table 200.

In step S331, the CPU 100 newly adds an empty line the end of the executing user table 200 acquired in S321.

In step S332, the CPU 100 records the work ID of the flow chart 90 acquired in S302 in a work ID 201 of the line generated by addition in S331 of the executing user table 200.

In step S333, the CPU 100 records the executing user ID acquired in S301 in the user ID 202 of the line generated by addition in S331 of the executing user table 200.

In step S334, the CPU 100 records 1 in an execution count 203 of the line generated by addition in S331 of the executing user table 200.

In step S335, the CPU records a value larger than the work history ID acquired in S316 by 1 in the latest work history ID 204 of the line acquired in S331 of the executing user table 200.

In step S336, the CPU 100 acquires the related information management table 160C.

In step S337, the CPU 100 acquires the m-th line (m: initial value 1) of the related information management table 160C acquired in S336.

In step S338, the CPU 100 acquires the work ID 161 of the m-th line acquired in S337.

In step S339, the CPU 100 determines whether the work ID acquired in S338 of the m-th line of the related information management table 160C matches the work ID acquired in S302 of the flow chart 90. If both work IDs match, the CPU proceeds to S340 and if both work IDs do not match, the CPU proceeds to S343.

In step S340, the CPU 100 acquires the most frequently executed user ID 165 of the m-th line acquired in S337 of the related information management table 160C.

In step S341, the CPU 100 determines whether the most frequently executed user ID acquired in S340 of the m-th line of the related information management table 160C matches the user ID acquired in S301. If both user IDs match, the CPU proceeds to S342 and if both user IDs do not match, the CPU proceeds to S350.

In step S342, the CPU 100 stores (overwrites) the table ID acquired in S305 of the actual work management table 150B in the actual work management table ID 163 of the m-th line acquired in S337 of the related information management table 160C.

In step S343, the CPU 100 increments the line number m acquired in S337 in the related information management table 160C by 1.

In step S344, the CPU 100 determines whether the line number m set in S343 is present in the related information management table 160C acquired in S336. If the line number is present, the CPU returns to S337 and if the line number is not present, the CPU proceeds to S345.

In step S345, the CPU 100 adds a new line to the end of the related information management table 160C acquired in S336.

In step S346, the CPU 100 enters the work ID acquired in S302 of the flow chart 90 in the work ID 161 of the line newly created in S345 of the related information management table 160C.

In step S347, the CPU 100 enters the work name acquired in S302 of the flow chart 90 in the work name 162 of the line newly created in S345 of the related information management table 160C.

Step S348 enters the user ID acquired in S301 in the most frequently executed user ID 165 of the line newly created in S345 of the related information management table 160C.

In step S349, the CPU 100 enters the table ID acquired in S305 of the actual work management table 150B in the actual work management table ID 163 of the line generated by addition in S345 of the related information management table 160C.

In step S350, the CPU 100 acquires the executing user table 200.

In step S351, the CPU 100 acquires the t-th line (t: initial value 1) acquired in S350 of the executing user table 200.

In step S352, the CPU 100 acquires the work ID 201 of the t-th line acquired in S351 of the executing user table 200.

In step S353, the CPU 100 determines whether the work ID acquired in S352 of the t-th line of the executing user table 200 matches the work ID acquired in S302 of the flow chart 90. If both work IDs match, the CPU proceeds to S354 and if both work IDs do not match, the CPU proceeds to S356.

In step S354, the CPU 100 acquires the user ID 202 of the t-th line acquired in S351 of the executing user table 200.

In step S355, the CPU 100 determines whether the user ID acquired in S354 of the t-th line of the executing user table 200 matches the most frequently executed user ID acquired in S340 of the m-th line of the related information management table 160C. If both user IDs match, the CPU proceeds to S357 and if both user IDs do not match, the CPU proceeds to S356.

In step S356, the CPU 100 increments the line number t acquired in S351 in the executing user table 200 by 1.

In step S357, the CPU 100 acquires the execution count 203 of the t-th line acquired in S351 of the executing user table 200.

In step S358, the CPU 100 determines whether the execution count acquired in S357 of the t-th line of the executing user table 200 is larger than the execution count (however, 1 when branched to NO from S328) acquired in S329 of the n-th line of the executing user table 200. If larger, the CPU proceeds to S359 and otherwise, the CPU proceeds to S342.

In step S359, the CPU 100 records (overwrites) the user ID acquired in S354 of the t-th line of the executing user table 200 in the most frequently executed user ID 165 of the m-th line acquired in S337 of the related information management table 160C.

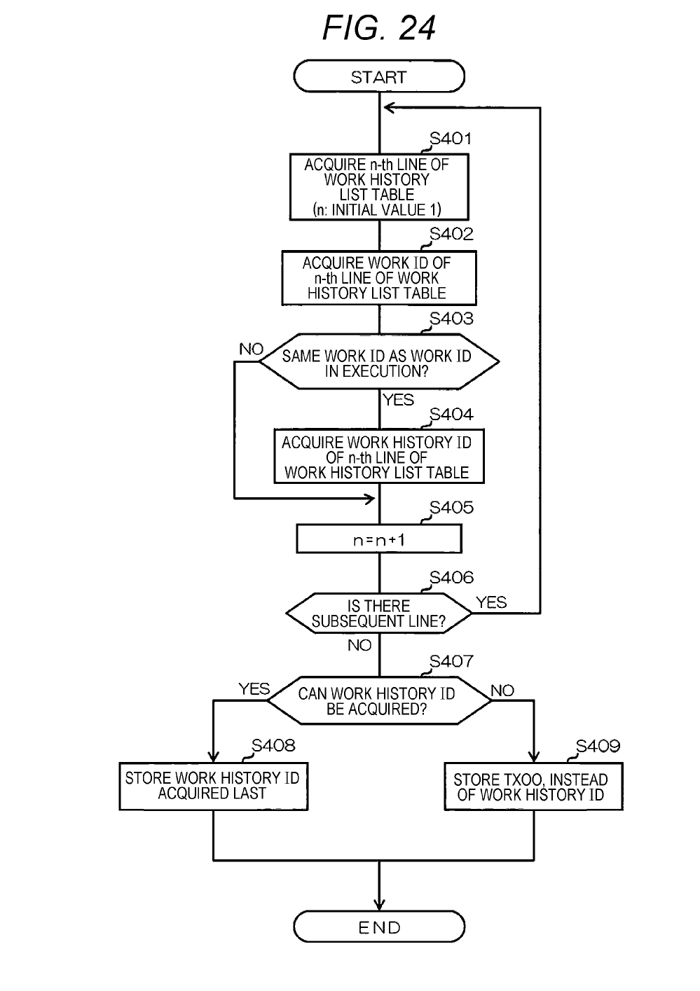

FIG. 24 shows the flow of processing (S316) of the latest work history ID acquisition in the above processing shown in FIGS. 21 to 23. This processing is processing to acquire the latest work history ID concerning the flow chart currently being executed from the work history list table 200.

In step S401, the CPU 100 acquires the n-th line (n: initial value 1) acquired in S414 of the work history list table 210.

In step S402, the CPU 100 acquires the work ID 212 of the n-th line acquired in S401 of the work history list table 210.

In step S403, the CPU 100 determines whether the work ID acquired in S402 of the n-th line of the work history list table 210 matches the work ID acquired in S302 (FIG. 21) of the flowchart. If both work IDs match, the CPU proceeds to S404 and if both work IDs do not match, the CPU proceeds to S405.

In step S404, the CPU 100 acquires the work history ID 211 of the n-th line acquired in S401 of the work history list table 210.

In step S405, the CPU 100 increments the line number n acquired in S401 in the work history list table 210 by 1.

In step S406, the CPU 100 determines whether the line number n set in S405 is present in the actual work management table 150B acquired in S314 (FIG. 21). If the line number is present, the CPU returns to S401 and if the line number is not present, the CPU proceeds to S407.

In step S407, the CPU 100 determines whether the work history ID 211 of the n-th line of the work history list table 210 is acquires at least once in S404. If acquired, the CPU proceeds to S408 and if not acquired, the CPU proceeds to S409.

In step S408, the CPU 100 stores the work history ID 211 acquired last in S404 of the n-th line of the work history list table 210 in the main storage device 110.

In step S409, the CPU 100 stores TX00 (X: lower one digit of the table ID of the flow information table 140 in the work) in the main storage.

The above is the acquisition processing of the latest work history ID.

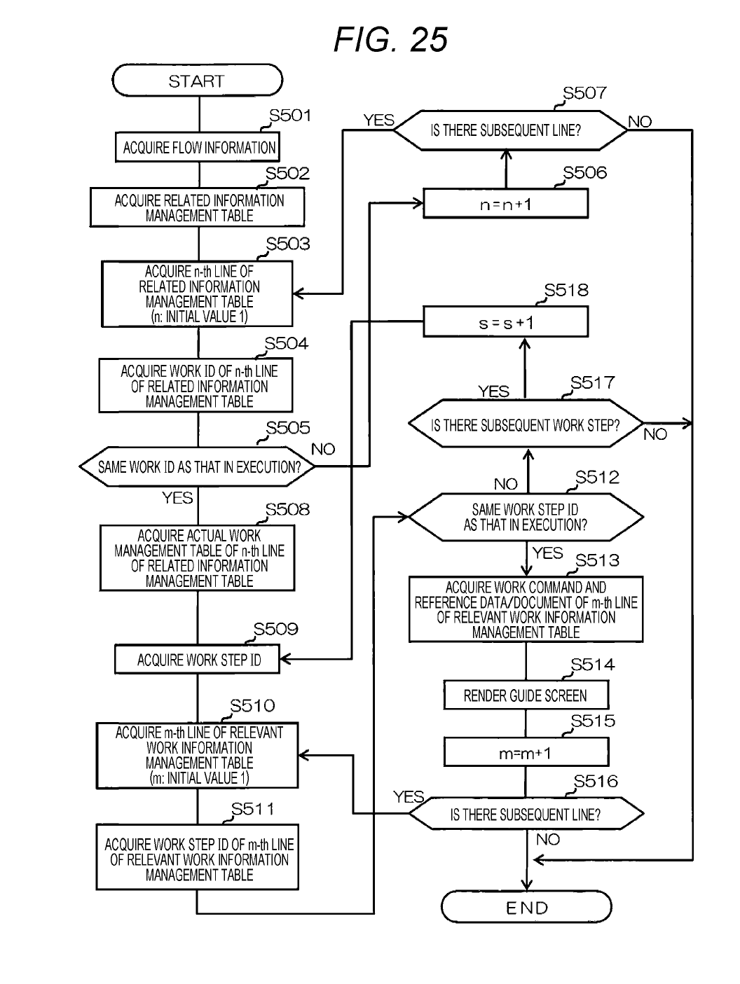

FIG. 25 shows the flow of processing of, when the operator performs work using the flow chart 90 shown in FIG. 20, the most frequently executing user of the work being extracted and the guide screen of each work node (step) of the screen unit 50 being caused to display work commands executed in the past and data/documents referred to by the most frequently executing user as recommendations by the information control/management server 10.

In step S501, the CPU 100 acquires the work ID of the flow chart executed by the operator this time from the flow table 130.

In step S502, the CPU 100 acquires the related information management table 160C.

In step S503, the CPU 100 acquires the n-th line (n: initial value 1) of the acquired related information management table 160C.

In step S504, the CPU 100 acquires the work ID 161 of the n-th line acquired in S503 of the related information management table 160C.

In step S505, the CPU 100 determines whether the acquired work ID of the n-th line of the related information management table 160C matches the work ID acquired in S501 of the flow chart 90. If both work IDs match, the CPU proceeds to S508 and if both work IDs do not match, the CPU proceeds to S506.

In step S506, the CPU 100 increments the line number n acquired in S503 in the related information management table 160C by 1.

In step S507, the CPU 100 determines whether the line number n set in S506 is present in the related information management table 160C acquired in S502. If the line number is present, the CPU returns to S503 and if the line number is not present, the CPU terminates the processing.

In step S508, the CPU 100 acquires the actual work management table ID 163 of the n-th line acquired in S503 of the related information management table 160C.

In step S509, the CPU 100 causes a transition to a node in the flow chart and acquires the work step ID of the node by referring to the flow information table 140.

In step S510, the CPU 100 acquires the m-th line (m: initial value 1) of the actual work management table 150B acquired in S508.

In step S511, the CPU 100 acquires the work step ID 152 of the acquired m-th line of the actual work management table 150B.

In step S512, the CPU 100 determines whether the work step ID acquired in S511 of the m-th line of the actual work management table 150B matches the work step ID in execution acquired in S509 of the flow chart. If both work step IDs match, the CPU proceeds to step S513 and if both work step IDs do not match, the CPU proceeds to step S517.

In step S513, the CPU 100 acquires the work command 153 and the reference data/documents 154 of the m-th line acquired in S510 of the actual work management table 150B.

In step S514, the CPU 100 causes the screen unit 50 of the client device 20 corresponding to the work step ID acquired in S509 of the flowchart to display the work command and reference data/documents acquired in S513 of the m-th line of the actual work management table 150B.

In step S515, the CPU 100 increments the line number m acquired in S510 in the actual work management table 150B by 1.

In step S516, the CPU 100 determines whether the line number m set in S515 is present in the actual work management table 150B acquired in S508. If the line number is present, the CPU returns to S510 and if the line number is not present, the CPU terminates the processing.

In step S517, the CPU 100 checks whether there is any node after the node acquired in S509. If there is still a node, the CPU proceeds to S518 and if there is no node, the CPU terminates the processing.

The above is the processing when recommendations are also made to be displayed in the screen unit 50 together with guide information.

According to a computer system in the third embodiment, work whose execution count is large in the same work can further be provided to the operator as recommendations. In general, with an increasing execution count, the likelihood that the work command thereof is a correct operation is considered to increase. Therefore, even an operator who is unfamiliar with the relevant work can perform the work by using recommendations.

If work content becomes more complex and diverse, even a skilled operator can also use recommendations as tips or for work confirmation, which can be considered to contribute to improvements of convenience.

What is provided as recommendations includes work commands and products thereof. A work command represents an operation itself of the operator and therefore, a concrete operation to be executed by the operator is provided to the operator who performs the work, achieving an effect of significantly improving convenience.

In the foregoing, the first to third embodiments to carry out the present embodiment, but the present invention is not limited to such examples and various combinations or modifications can be made without deviating from the spirit thereof.

For example, version management in the second embodiment may also be applied to reference data/documents of recommendations of a computer system in the third embodiment to allow reference data/documents of updated (for example, latest) versions to be displayed in recommendations. Alternatively, in place of reference data/documents during work in the past, only updated reference data/documents may be provided. This case can be said to more serve the purpose of making recommendations.

### REFERENCE SIGNS LIST

10 information control/management server
50 screen unit
50, 90 flow chart
61 to 64, 91 to 95 work node (step)
70a to 70c, 88 guide
71b to 71c, 80 input field
74a to 74c search result
81a to 81c product name
99 recommendations
113 flow information acquisition unit
114 related information management unit
115 version management unit
130 flow table
140 flow information table
150, 150B actual work management table
160 related information management table
190 version management table

1. A computer comprising:
a storage unit configured to hold information associating a flow chart including at least one work procedure and showing a flow of work needed to generate predetermined data and work guide information needed to perform the work procedure, wherein
the flow chart and the guide information are transmitted in response to a directive from a requesting computer and the requesting computer is caused to display the flow chart and the guide information,
a combination of a work command issued by the requesting computer and data accessed or generated in accordance with the work command for execution of the work procedure is associated with the work procedure and recorded, and
the flow chart corresponding to the predetermined data and the combination of the work command in the work procedure stored and the data accessed or generated are transmitted to the requesting computer in a predetermined moment to cause the requesting computer to display the flow chart and the combination.

2. The computer according to claim 1, wherein
the work command includes a directive command of data searching, and
the data accessed includes a search result of the data searching or data selected from the search result.

3. The computer according to claim 1, wherein
the predetermined moment is when the work procedure is performed again.

4. The computer according to claim 1, wherein
an update of the data accessed or generated is further managed,
the data updated and the data accessed or generated are further associated and stored, and
information about the data after the update is further transmitted to the requesting computer in the predetermined moment to cause the requesting computer to display the information.

5. The computer according to claim 4, wherein
the information about the data after the update include information about a version of the data after the update.

6. The computer according to claim 4, wherein
the information about the data after the update include a data name before the update.

7. The computer according to claim 1, wherein
the combination and the work procedure recorded after being associated are further recorded after being associated with an operator ID who performs the work procedure and
an execution count of the work procedure is further managed based on the operator ID and when the flow chart and the guide information are transmitted in response to the directive from the requesting computer, the combination corresponding to the operator ID is further transmitted in accordance with the execution count.

8. The computer according to claim 7, wherein
when the flow chart and the guide information are transmitted in response to the directive from the requesting computer, the combination corresponding to the operator ID is further transmitted in accordance with a largest execution count.

9. A method of providing guide information of a computer including a storage unit configured to hold information associating a flow chart including at least one work procedure and showing a flow of work needed to generate predetermined data and work guide information needed to perform the work procedure, wherein
the computer
transmits the flow chart and the guide information in response to a directive from a requesting computer and causes the requesting computer to display the flow chart and the guide information,
records by associating a combination of a work command issued by the requesting computer and data accessed or generated in accordance with the work command for execution of the work procedure with the work procedure, and
transmits the flow chart corresponding to the predetermined data and the combination of the work command in the work procedure stored and the data accessed or generated to the requesting computer in a predetermined moment to cause the requesting computer to display the flow chart and the combination.

10. A non-temporary recording medium storing a program a computer including a storage unit configured to hold information associating a flow chart including at least one work procedure and showing a flow of work needed to generate predetermined data and work guide information needed to perform the work procedure, processor, and a memory is caused to execute, wherein
the computer is caused to
transmit the flow chart and the guide information to display in a requesting computer in response to a directive from the requesting computer,
record by associating a combination of a work command issued by the requesting computer and data accessed or generated in accordance with the work command for execution of the work procedure with the work procedure, and
transmit the flow chart corresponding to the predetermined data and the combination of the work command in the work procedure stored and the data accessed or generated to the requesting computer in a predetermined moment to cause the requesting computer to display the flow chart and the combination.
